(19) United States
(12) Patent Application Publication
(10) Pub. No.: US 2022/0357724 A1
(43) Pub. Date: Nov. 10, 2022

(54) IIoT Agent Device

(71) Applicant: Fung Chin CHEUNG, Hong Kong (CN)

(72) Inventor: Fung Chin CHEUNG, Hong Kong (CN)

(21) Appl. No.: 17/432,588

(22) PCT Filed: Sep. 11, 2020
(86) PCT No.: PCT/IB2020/058476

§ 371 Date: Aug. 20, 2021

(30) Foreign Application Priority Data
Sep. 13, 2019 (HK) 19129656.5

(51) Int. Cl. G05B 19/418

(52) U.S. Cl. CPC G05B 19/4188; G05B 19/41885; G05B 19/4185; G05B 2219/23005; G05B 2219/23288; G05B 2219/25168

(57) ABSTRACT

An Industrial Internet of Things (IIoT) agent module or device preferably used as or in place of a Supervisory Control and Data Acquisition (SCADA) data node system and/or conventional SCADA system, which is operatively coupled and in communication with an IIoT cloud platform, so as to perform control and data acquisition operations and exchange data and commands automatically or in response to Inputs from the IIoT cloud platform; wherein all production details/settings/parameters, including process logic, control methodology, product recipe, and data point setup, can be dynamically changed based on decision/input/command of the IIoT cloud platform, such that the IIoT cloud platform might completely “re-configure/re-program” a software portion of the IIoT agent module or device governing its working behavior or characteristics by sending a reconfiguration/reprogramming information.

### FIELD

The present disclosure generally relates to Industrial Internet of Things (and more particularly,), and more particularly to an IIoT agent module or device, preferably used as or in place of a Supervisory Control and Data Acquisition (SCADA) data node system and/or a conventional SCADA system, which enables various field devices and/or programmable logic controller (PLC) and their associated/controlled devices to be connected to and more particularly for carrying out required operations.

### BACKGROUND

Nowadays, people are concerned about whether IIoT will replace the traditional SCADA system and some have proposed to replace SCADA system with IIoT. But in reality, the traditional automated systems are still there, and new established plants are still using the proprietary SCADA, PLC and field bus networking. The reasons are simple. Field bus networking is still more reliable than Internet connection, PLC control is still more reliable than cloud control, and industrial processes or manufacturing processes can't tolerate any single signal miss or delay during operations since any missing signal in industrial processes may cause operation failure, damage to equipment, loss of life, huge loss of money, and/or safety issues. Therefore, there is a long-term need in the art for a system, device, and/or method capable of solving the above problems, such that the existing SCADA system, PLC and field bus network could be combined with IIoT to perform required operations and realize an expected production result and/or efficiency.

### DISCLOSURE

Therefore, the embodiments of the present disclosure preferably seek to alleviate, mitigate, or eliminate, individually or in any combination, one or more defects, shortcomings or problems in the art as identified above, by providing systems, devices and methods according to the appended claims.

One of the aspect of the present disclosure has proposed an Industrial Internet of Things (IIoT) agent module or device, preferably configured to take part in an automated IIoT system and used as or in place of a Supervisory Control and Data Acquisition (SCADA) data node system and/or a conventional SCADA system, which is operatively coupled and in communication with an IIoT cloud platform, so as to perform a supervisory control and data acquisition operation and exchange data and command automatically or in response to an input from the IIoT cloud platform; wherein all production details, settings, or parameters, including process logic, control methodology, product recipe, and data point setup, can be dynamically changed based on a decision, input, or command of the IIoT cloud platform, such that the IIoT cloud platform might completely “re-configure or re-program” a software portion of the IIoT agent module or device governing its working behavior or characteristics by sending a reconfiguration/reprogramming information or message; wherein the “reconfiguration/reprogramming” information is equivalent to the configuration of the IIoT agent module or device.

In some embodiments, wherein the IIoT agent module or device is configured to be disabled/idle or inactivated during initial startup or operation, until the IIoT cloud platform performs initial configuration or reconfiguration/reprogramming for it; and the IIoT agent module or device is configured to control and monitor production after being configured or reconfigured/reprogrammed by the IIoT cloud platform, and then transfer corresponding preset or agreed data to the IIoT cloud platform; and the IIoT cloud platform might implement a machine learning algorithm based on the data, and might send a reconfiguration/reprogramming instruction to the IIoT agent module or device at any time to realize a complete control loop of IIoT system.

In other embodiments, wherein the IIoT agent module or device is configured to operate in a “micro” environment of manufacturing for collecting and visualizing a day-to-day operation data of a factory or a process; and the IIoT cloud platform is configured to concentrate on a “macro” environment of manufacturing for solving pertinent questions hanker in quest for optimal productivity.

In some embodiments, wherein the IIoT agent module or device is configured to provide security assurance to the IIoT cloud platform; wherein the IIoT agent module or device is preferably configured to have direct connection between field devices and/or programmable logic controllers (PLCs) for conducting supervisory control and data acquisition operations, and transmit an accurate data and result to the IIoT cloud platform, so as to ensure accuracy of signal communication of control system and system security of IIoT.

In other embodiments, wherein all data points setup could be taken place in the IIoT cloud platform, such that kind and number of data points being transferred could be designed based on configuration details/detailed data in IIoT cloud platform; and/or the configuration details/detailed data in the IIoT cloud platform can be changed in anytime, from any place to demand more different types of data point transfer to facilitate interoperability of system.

In further embodiments, wherein adding a new device or changing connection infrastructure might be taken place in configuration process of IIoT cloud platform to facilitate scalability of system, and a new configuration will then be delivered to a corresponding IIoT agent module or device, so as to monitor and control the new device accordingly; preferably, any amendment of current configuration in IIoT agent module or device might be completely done at one time in a IIoT cloud platform at remote side, so that there is no need to repeatedly perform configuration updates on both the IIoT agent module or device and the IIoT cloud platform through manual operations; and wherein configuration consistence could be assured between IIoT agent module or device and the IIoT cloud platform, as if, by mistake, the configuration between them are somehow different, data points transfer will be mismatched, such that a system behavior may not be as same as an expectation of the IIoT cloud platform.

In yet still other embodiments, wherein the IIoT agent module or device is configured to actually works on behalf of the IIoT cloud platform to perform supervisory control and data acquisition duty, so as to facilitate centralized control of system; and wherein actual behavior and outcome of production must obey to willingness of the IIoT cloud platform, and any misbehavior of IIoT agent module or device might be regulated via a remote configuration update, such that the IIoT cloud platform could take full control of whole manufacturing process.

In some embodiments, wherein a new IIoT agent module or device can be integrated onto the IIoT cloud platform to perform manufacturing simulation according to a reconfiguration/reprogramming information or instruction, such that issues related to safety and/or production efficiency of IIoT system employing a newly configured IIoT agent module or device could be solved or reduced by predicting potential risks of the new configuration before using the newly configured IIoT agent module or device.

In further embodiments, wherein the IIoT cloud platform is configured to comprise a real-time data storage area for storing/collecting a real-time data of production and preferably a real-time data generated/collected during factory production, and a simulation data storage area for storing/collecting a data during manufacturing simulation, and a configuration profile data storage area for storing/collecting a configuration setup data of all IIoT agent modules or devices, and such storage areas are arranged for simulation processing; wherein a production result and/or efficiency depends on the configuration setup data, and the configuration setup data is preferably determined by at least one manufacturing simulation/testing, and when a new configuration setup data is determined/configured, a manufacturing simulation is conducted to output a simulation data with the new configuration setup data, and the simulation data is compared with a real-time data inputted/collected in advance to determine whether the new configuration setup data realizes an expected production result and/or a target value of efficiency; and/or the IIoT cloud platform is configured to further comprise an AI (artificial intelligence) processing module to facilitate the comparison between the simulation data generated with the new configuration setup data and the real-time data inputted/collected in advance to determine whether the new configuration setup data realizes an expected production result and/or a target value of efficiency, and a new configuration setup data is generated when the expected production result and/or target value of efficiency had not been realized, and then a manufacturing simulation is conducted repeatedly to output a new simulation data for comparison with the real-time data inputted/collected in advance, until the expected production result and/or the target value of efficiency had been realized; and/or a communication/information transfer processing module to facilitate transmission of data, information, and/or control commands between the IIoT agent module or device and the IIoT cloud platform; and/or a corresponding number of IIoT agent module or device required by or configured for manufacturing simulation, wherein IIoT agent module or device at remote side comprises a device driver program or a device driver for external communication with an external device, while the IIoT agent module or device of the IIoT cloud platform comprises a simulation driver program or a simulation driver dedicated for internal communication of the IIoT cloud platform.

In yet still other embodiments, wherein two or more IIoT agent modules or devices can form a group to provide a clustering of IIoT agent modules or devices, whereby enabling a switching over from a problematic IIoT agent module or device to a standby IIoT agent module or device for reducing downtime or idle hour via a remote configuration mechanism when a hardware failure occurs; and preferably, a clustering model of IIoT agent modules or devices comprises a duplicated clustering model employing a double amount of IIoT agent modules or devices adapted for working in pair, wherein one of each pair of the IIoT agent modules or devices is an active IIoT agent module or device, and the other is a standby IIoT agent module or device, and a switch over might happen between each pair of IIoT agent modules or devices; and a N+1 clustering model employing N active IIoT agent modules or devices and a singular standby IIoT agent module or device for enabling a switch over therebetween.

Therefore, according to the present disclosure, the IIoT agent module or device can not only solve the shortcomings of the technical solutions of existing data node SCADA, but also has more advantages. For example, a very important concept or teaching of the present disclosure is that the integration of the IIoT agent module or device with the IIoT cloud platform allows manufacturing simulation, so that the potential risks of new configuration could be preindicated/predicted before actual production, so as to solve in a better way the various safety issues of the new technology/new type IIoT.

### FIGURES

These and other aspects, features and advantages that might be realized by embodiments of the present disclosure will become apparent and clear by way of the following description of the embodiments of the present disclosure with reference to the accompanying drawings, wherein:

FIG. 1 is a schematic block diagram of an embodiment of an example IIoT agent device/system according to the present disclosure;

FIG. 2 is a schematic block diagram of another embodiment of an example IIoT agent device/system according to the present disclosure;

FIG. 3 is a schematic block diagram of a further embodiment of an example IIoT agent device/system according to the present disclosure, wherein IIoT agent modules or devices forming a clustering/group are employed;

FIGS. 4a-4c show respective schematic block diagrams of internal design/features of example IIoT agent devices according to the present disclosure; and

FIG. 5 is a schematic block diagram of data structure of an example IIoT agent device and its specific application according to the present disclosure.

### DESCRIPTION

Specific embodiments of the present disclosure will now be described with reference to the drawings. However, the present disclosure can be implemented in many different forms, and should not be construed as being limited to the embodiments set forth herein; on the contrary, these embodiments are provided to make the content of the present disclosure clear and complete, and to convey fully the scope of the present disclosure to those skilled in the art. The terms used in the detailed description of the embodiments depicted in the drawings are not intended to limit the present disclosure. In the drawings, similar/resembling numerals indicate similar/resembling parts.

According to present disclosure, are all in the age of transition from Industry 3.0 to Industry 4.0 and definitely need some advance tools to leverage the power of Industry 4.0. In the era of Industry 3.0, traditional industry, technologies such as field bus connectivity, sensors, PLC control, local networking, software control such as SCADA (supervisory control and data acquisition), have all been used in manufacturing sector for many years. Some SCADA even have optional data analytics and embedded intelligence to boost automated processes for better manufacturing performance.

Therefore, industries have long relied on proprietary field network, individual computer systems and sensors to control equipment and to monitor operations. This is what people call automation systems. But as people enter the fourth era of industry 4.0, these systems and sensors are becoming more interconnected and are leveraging machine learning to automate industrial processes.

Such systems are what people usually call IIoT, IoT for Industrial purpose, that is cloud based solution for all kind or devices communicating with all kind of applications to make a smart collaborative environment. The IIoT is significant because a device that can represent itself digitally becomes something greater than the device by itself. No longer does the device is used for just one propose, but it is now connected to other connected devices and their stored data in the cloud. When many devices act in unison, some form of ambient intelligence will come out.

IIoT is nothing magic. The traditional automated systems are still there. New established plants are still using the proprietary SCADA, PLC and field bus networking. The reasons of this frustration are simple. Field bus networking is still more reliable than Internet connection, PLC control is still more reliable than cloud control, and industrial processes can't tolerate any single signal miss or delay during operations since any missing signal in industrial processes may implicate huge loss of money, something damaged and safety issues.

Therefore, according to the present disclosure, IIoT cannot completely replace the traditional SCADA system. Because the basic requirement of industrial automation is “safety”, it is also the core principle of operational technology (OT, namely the hardware and software dedicated to detecting or causing changes in physical processes through direct monitoring and/or control of physical devices such as valves, pumps, etc.).

Although IIoT will not negate the need to securely open and close valves, start or stop motors or reset an actuator when proper signal has received, it is still a long road for cloud IIoT solution to prove its reliability.

Security is also another important factor in the SCADA system because of its usage in sensitive operations with specialized protocols, proprietary interfaces and a closed network.

SCADA emphasis on the securely control and monitoring and therefore standard SCADA have similar packed features such as schematic visualization, alarming, data logging, real-time control and historians. Obviously, these features are still not enough to fulfill the goals of Industry 4.0 to provide quicker, cheaper, personalized and with better quality products to consumers.

According to the present disclosure, since IIoT heavily rely on the cloud platform to store day-to-day massive production data and to implement various deep learning and machine learning algorithms, there is a demand to pass data from automation systems to the cloud platform. A common solution is to create a connection between SCADA and IIoT cloud platform. SCADA will be treated as a data node to exchange data with IIoT cloud platform. This kind of SCADA might be called as data-node SCADA, wherein SCADA still work as traditional way and IIoT cloud platform is focusing on analyzing machine data to improve productivity and to impact upper/top line management. However, this is not a perfect solution, which is just a partial solution fulfilling the needs of IIoT system.

According to present disclosure, interoperability, scalability, information transparency, decentralized data, and centralized control are the five essential principles to distinguish IIoT from SCADA system. Making a connection between data-node SCADA and IIoT cloud platform obviously can make the data and information transparency and decentralize data to cloud platform and elsewhere. However, the remain 3 are just partially realized due to data-node SCADA still pay an important role in whole system.

Interoperability is the ability for IIoT to communicate between the whole system, where all the system devices (regardless of made of, version, model or manufacturer) can collect or exchange data with each other. So, if using data-node SCADA solution, interoperability of IIoT will depends on how much data would be released to cloud platform. The more data data-node SCADA can release, the higher interoperability IIoT have. But, owing to safety and security reasons, data in SCADA can be released to IIoT cloud platform are usually very limited.

Scalability is the ability for IIoT to add devices or change infrastructure of the whole system. Obviously, adding physical devices to automated systems need to define device details in the data-node SCADA first. That means similar exercise must be repeated in IIoT cloud to match what data-node SCADA have done. It will take long to setup if the plants are in different counties and regions from central plant. It also has consistent problem if data-node SCADA and IIoT cloud are provided by different suppliers. Even worst, some tailor-made data-node SCADA is unable to extend its capabilities to add new devices or to change settings as required.

Centralized control is the ability for IIoT to control all physical devices as a whole to pursuit the objective of Industry 4.0. In general, it is data-node SCADAs to operate those devices and sensors. All production details, process logic and product recipe are still storing in data-node SCADAs. All data-node SCADAs in the various plants are still conquering the production. If IIoT cloud needs to perform some strategy change in industrial processes based on its result from deep learning of production data, it properly has no way to change data-node SCADAs' behavior and finally fail to adjust industrial processes to make better productivity or better quality as in Industry 4.0.

In order to break through the issue of being isolated of the data-node SCADA, the role of data-node SCADAs must be demoted, and its control right must be handover to the IIoT cloud platform. Imagine that data-node SCADAs are a small kingdom in various islands of a country. Each island has their own law and culture. Although one might build the bridges to those islands, all islands still work their own way. In order to make the country united, those islands must somehow demote to command executors.

Therefore, according to the present disclosure, data-node SCADA should be demoted to IoT agent module or device which is a computer software or dedicated hardware that acts for IIoT cloud platform to perform supervisory control and data acquisition just like normal SCADA does. It also creates a communication channel with IIoT cloud platform to exchange data and command as same as data-node SCADA. The difference is all the production details such as process logics, control methodology, product recipes and data points setup can be dynamically changed upon the IIoT cloud platform decision. That means IIoT cloud platform can completely “re-program/reconfigure” the working behavior of the IIoT agent. That “re-programming/reconfiguration” information would be called configuration of IIoT agent.

In some embodiments, IIoT agent module or device is initially (when it starts to run) just a dummy/idling software/hardware which has done nothing but just wait for IIoT cloud platform configuration. After all, IIoT agent module or device performs just like a normal SCADA to control and monitor the production and then transfer the agreed data to IIoT cloud platform. Based on these data, IIoT cloud platform can implement some machine learning algorithms and will command reconfiguration to IIoT agent in anytime if necessary, whereby completing a system control loop of IIoT.

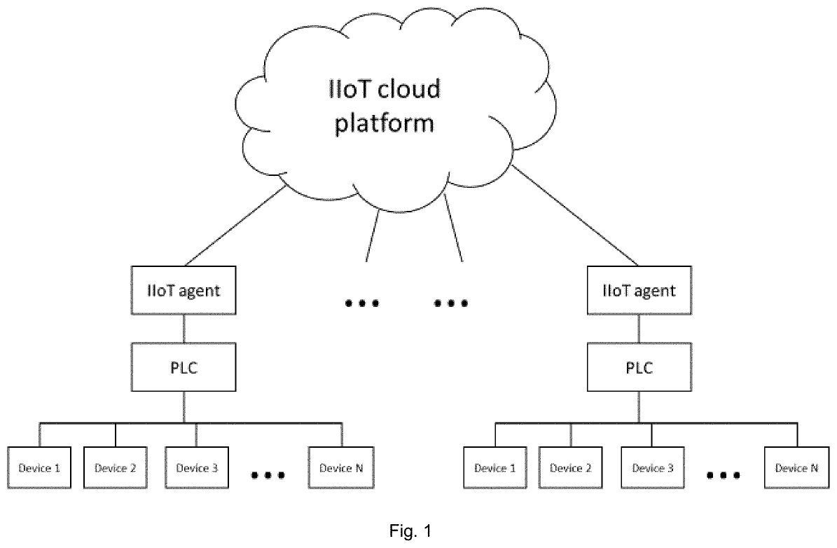

As shown in FIG. 1, the IIoT agent module or device that is preferably used or in place of the Supervisory Control and Data Acquisition (SCADA) data node runs in the “micro” environment in relation to manufacturing, collecting and visualizing the day-to-day operations data of a factory or process. Whereas IIoT cloud platform can concentrate on the “macro” environment, and more pertinent questions hanker in the quest for optimal productivity.

As mentioned above, safety is the core principle of OT so that accurate signals communication between the whole system must be guaranteed. With IIoT agent module or device, IIoT cloud platform can promise the accurate communication by commissioning the supervisory control and data acquisition job to local IIoT agent module or device which has direct connection between field devices and PLCs. IIoT agent module or device is the complement of lacking safety promising for IIoT cloud platform.

For interoperability, since all data points setup is taken place in the IIoT cloud platform, the kind and number of data points being transferred are designed by configuration details in IIoT cloud platform. if necessary, IIoT cloud platform can change the configuration details to demand more different kind of data points transfer in anytime, from any place.

For scalability, adding a new device in the system or changing connection infrastructure are also taken place in configuration process of IIoT cloud platform. The new configuration then is delivered to relevant IIoT agent module or device, which will monitor and control the new device accordingly. IIoT agent module or device is advantageous in two aspects. First, any amendment of current configuration in IIoT agent module or device can be completely done only in remote IIoT cloud platform for once only. Then, remote configuration update can avoid too much travelling for software engineers who need not to do twice at different places every time they make changes to the automated system. Second, configuration consistence can be assured between IIoT agent module or device and IIoT cloud platform. if, by mistake, the configuration between them are somehow different, data points transfer will be mismatched, and system behavior may not be as same as IIoT cloud platform expectation.

For centralized control, IIoT agent module or device actually works on behalf of IIoT cloud to perform supervisory control and data acquisition duty. Actual behavior and outcome of production must obey to IIoT cloud willingness. Any misbehavior of IIoT agent module or device can be regulated by the updates of configuration. So, IIoT cloud are the master who take full control of whole manufacturing process.

IIoT agent modules or devices can not only solve those unperfect data-node SCADA solutions, but also can have more benefits. For example, integration of IIoT agent module or device onto the IIoT cloud platform to preform manufacturing simulation has further resolved various safety issues of new technology IIoT by predicting the potential risk of new configuration before making it live or before real manufacturing. This is very important concept.

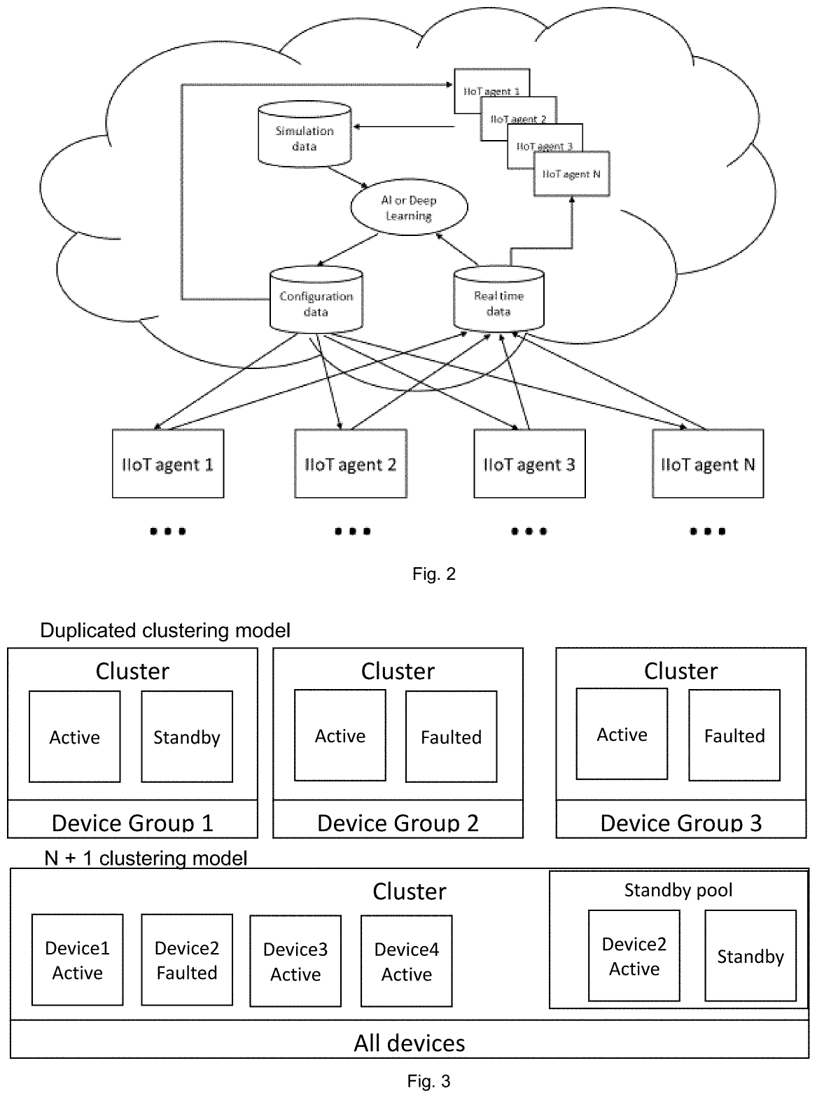

Referring to FIG. 2, there is a group of IIoT agent modules or devices that take part in an automated system's supervisory control and data acquisition at the remote side for a factory. Each agent has its own control zone or specific purpose. These IIoT agent modules or devices continuously send what they capture from the manufacturing environment to IIoT cloud platform. The more frequent these IIoT agent modules or devices capture the data, the best analyzed results for AI or simulation processing they will get in the IIoT cloud.

In the IIoT cloud platform, three storage areas will be set up for simulation processing, including a real-time data storage area for storing/collecting a real-time data of production and preferably a real-time data generated/collected during factory production, and a simulation data storage area for storing/collecting a data during manufacturing simulation, and a configuration profile data storage area for storing/collecting a configuration setup data of all IIoT agent modules or devices. Some other processing modules such as AI, messaging/communication modules may exist in there also. On the other hand, a same number of IIoT agent module or devices is also running at there for manufacturing simulation. The only difference is that remote group agents at remote side contain device drivers/programs for external device communication, while cloud group agents at the cloud platform are equipped with simulation drivers/programs for IIoT cloud platform internal communication only.

When the IIoT cloud platform receives data, it will be immediately stored into real-time storage area. In the later time, these data and message stream will become an endless data source for simulation agents in cloud platform. Simulation agents process the data stream and then give out the results simulation data which will be stored in simulation data area.

Theoretically, if the configuration profiles for both IIoT agent module or device groups are same, both groups would produce similar outputs. But, when users change any configuration details, for example adding a new machine, in configuration storage area, the outputs of simulation would be varying according to the changes. By comparing the data between these real-time data and simulation data, users would figure out the relation and characteristics between those parameters. This simulation procedure can be repeated until user can find the best configurations for each IIoT agent module or device in terms of productivity, quality and safety.

These best configurations might then be saved back to configuration storage area. User can transfer these configurations to remote IIoT agent module or devices in planned maintenance schedule. After updating the IIoT agent module or devices, new set of data will be collected and sent to IIoT cloud platform. Next simulation with different objectives is started. This remote configuration mechanism makes IIoT users more flexible to adjust the manufacturing processes. To compare with traditional SCADA system, modification details must be done in remote site and are hard to be proved before making it live. This makes us hard to pursuit the utopia of Industry 4.0.

Referring to the schematic diagram of FIG. 3, another advantage of using IIoT agent module or device is that two or more IIoT agent module or device can form a group to provide a clustering of IIoT agent module or device. Hardware failure is one of common incidents happening all the time. In traditional SCADA, a downtime may not be avoided. With the remote configuration mechanism, the IIoT agent module or devices can provide a clustering by switching over from problematic IIoT agent module or device to the standby IIoT agent module or device. In short, user have to setup more IIoT agent module or devices than the need in the remote side. Setup the number of IIoT agent module or device in need at the beginning. The rest of IIoT agent module or devices will be setup with empty configuration and assigned to standby mode which has nothing to do but waiting for further instruction from IIoT platform.

As shown in FIG. 3, there are two clustering models. First, Duplicated clustering model needs double amount of IIoT agent module or devices. IIoT agent module or devices are work in pair, one is active, and the other is standby. The switch over is just happening between these two agents. Second is “N+1” clustering model. That is, for any N active IIoT agent module or devices, 1 more standby agent will be provided for switch over. Each model has its own advantages, the choice will depend on the network design or project specification.

Localized decisions for supervisory control of machines such as securely turning a valve off or alerting a leak can now be taken with the help of IIoT agent module or device without any human interference. Implementation of various deep learning and machine learning algorithms might enable the IIoT cloud platform to take decisions by identifying manufacturing patterns. Popular applications like automation and predictive maintenance are already using some of these features. Predictive maintenance completely eliminates the possibility of unexpected machine breakdown which greatly reduces maintenance cost. That is what Industry 4.0 promote to manufacturers.

According to the present disclosure, in order to provide the above capabilities of the IIoT agent module or device, its design may include the following elements/features:
1. Modular design.
2. SCADA features such as real-time control, data logging, data exchange, data analyzing, alarm handler and visualization.
3. Dynamic scripts/programs/command processes for triggering function and logic engine.
4. Interchangeable industrial communication protocol drivers/programs.
5. Interchangeable Internet protocol handlers/programs.
6. Remote data points setup.
7. Remote scripts update.
8. A simulation module.
9. Visualization Module
10. Data Registers.

Modular design means to separate all functions of IIoT agent module or device into various individual running instance. Each running instance has its own unique function. The collection of these instances is a solution package for different industrial fields. By selecting different combination of instances in the package, different application requirements can be tackled without the needs of touching any programming. From time to time, more specific modules would be added for particular purposes. This individual instance architecture must be adopted in the design since everything about IIoT agent module or device must be configurable by picking few module instances to work out for various application environment.

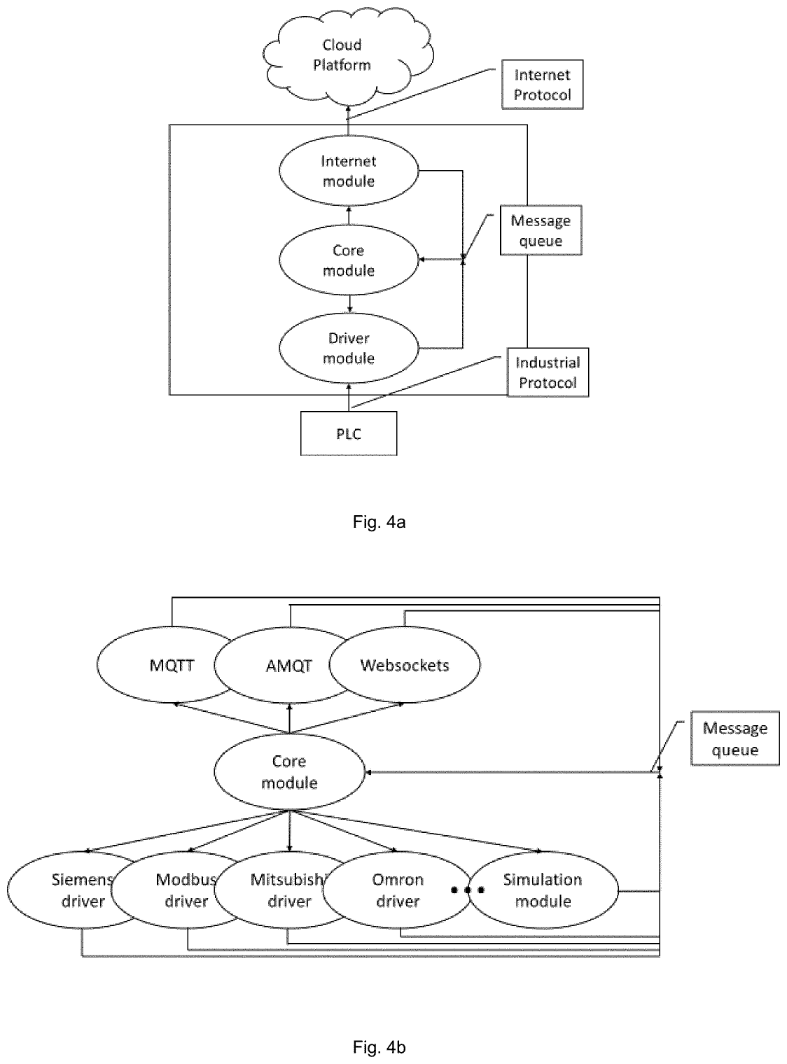

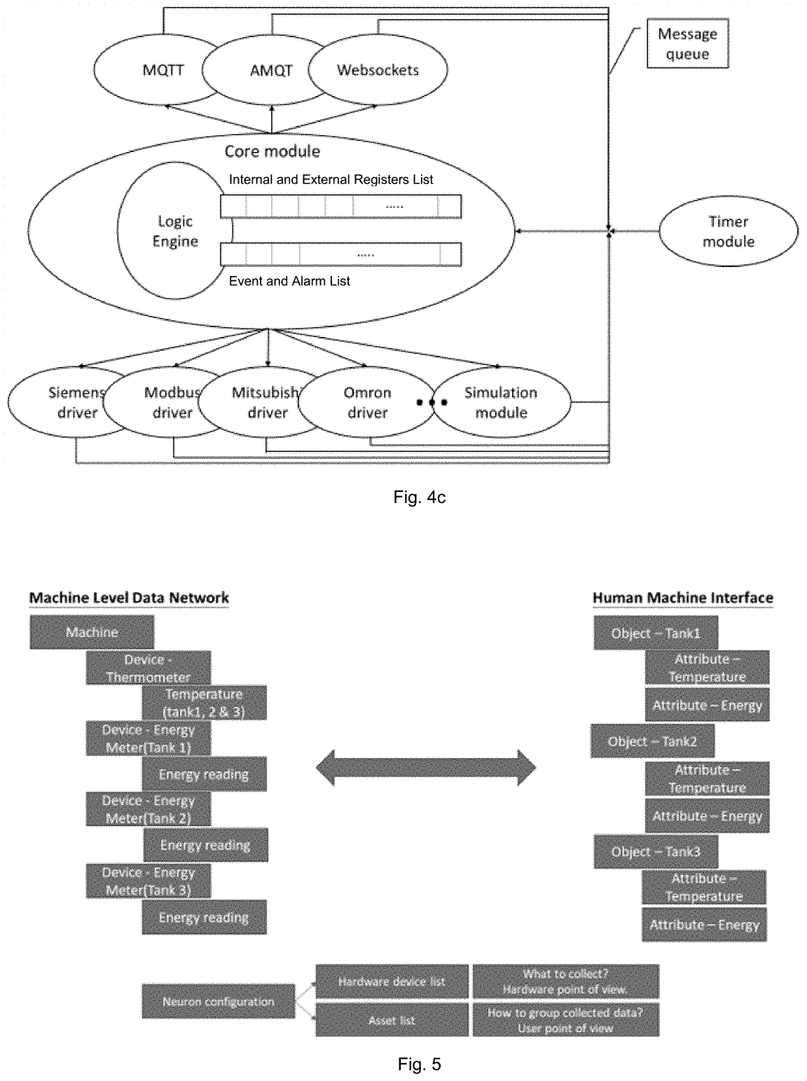

As shown in FIG. 4a, basically, there are three main categories of module in IIoT agent module or device design. First, Internet modules are used for communicating with Internet devices, IIoT cloud and HMI devices, through various Internet protocols such as MQTT, CoAP, Websockets, SOAP, AMQP and etc.

Industrial driver programs/driver modules are used for communicating with field bus devices, PLC, equipment and automated system through various Industrial protocols such as Modbus, Ethernet/IP, BACnet and some proprietary protocols for branded PLC such as Mitsubishi, Siemens, Allen-Bradley, and Omron. Lastly, core modules are used for data switching, processing and manipulation.

Industrial driver modules would take part in low level data acquisition and control command delivery. Internet modules will take part in data exchange with IIoT cloud. In the middle, core module would perform data processing and manipulation. There must be internal mechanism for these modules to communicate to each other. Message queues, IPC in Linux system, would be used as data tunnel for transferring data. Other modules can also get the data through their message queues. That means each new created module must establish a dedicated message queue for reading data and share the “feedback” message queue for writing back data. In computer science, inter-process communication or interprocess communication (IPC) refers specifically to the mechanisms an operating system provides to allow the processes to manage shared data. IPC is very important to the design process for microkernels and nanokernels.

There are thousands of industrial protocols using in the automated plants as those just listed as above. Unfortunately, each device just supports one or two protocol. To connect all equipment and devices in the automated plants, one must prepare all kinds of protocol driver modules in IIoT agent module or device as many as possible in advance. These drivers must be replaceable to each other or can run several instances in parallel to communicate with various devices at the same time. The Internet protocol modules have also similar design to be interchangeable.

When using the IIoT agent module or device in IIoT cloud platform for simulation, a simulation module must be employed to replace the driver modules. This simulation will connect to messaging system or database or whatever data stream processors. It reads historical data the IIoT agent module or device collect in previous time for simulating the output.

Referring to FIG. 4b, in the core module, a list of data registers would be constructed for storing the data reading from the devices. Each node with attached device address in the list represents one data point of the device. This register list will be kept data in sync automatically with registers in various devices. The sync period can be setup individually in each node of the register list. Moreover, there are some registers which do not link to any devices. These “internal” registers are usually used as temporary storage for calculation or data processing. So, the registers with external device address links are used for read/write device registers.

Referring to FIG. 4c, in addition to the data register list, the core module also maintains the event and alarm list. This list is used for chasing something happened in the devices or plants. By comparing any two external or internal registers in the register list, the flag of event point or alarm point would be triggered when the pre-defined condition goes on. When trigger is happening, flag stored in share memory goes on. A certain pre-defined script routine will be implemented, and system will record the alarm happening time and relevant values.

As mentioned above, IIoT agent module or device will act for IIoT cloud to control various devices and equipment. Issuing the control statements by IIoT cloud is the best authorization method to implement the centralized control ability. The collection of these statements is a script that can be remotely transferred to IIoT agent module or device. IIoT agent module or device support dynamic amendment of scripts that can be modified in any time, even in running state of devices or equipment.

According to the present disclosure, the IIoT cloud platform is an Internet-based computing process/method/means. In this way, shared software and hardware resources and information can be provided to various terminals of computer and other devices as required. For example, it provides users with infrastructure hosting and developer products, used to build a series of programs from simple websites to complex applications, and provides a series of modular cloud-based services and a large number of development tools, hosting and computing, cloud storage, data storage, translation API, forecasting. The cloud platform can be set at any side of the network, for example, in a private cloud or an intranet.

The various parts of the programming environment are running in a sequential order. First there is an idle loop (time interrupt) of one second before the main program starts. After finishing the main program, the system checks the running mode. If it is in pause mode, or if the communication with the control system is down, the system starts all over with the idle loop. If it is in semi-auto mode, the system continues with the manual mode program. If it is in auto mode, the system first continues with the auto mode program.

All parts (main, manual mode, service mode and auto mode) can make calls to subroutines. Subroutines can call other subroutines or call itself (recursive call). However, care should be taken when calling subroutines, so it will not become an endless loop.

All changes in the program can be made while running the line. Of course, there could be some side effect if making an erroneous change.

The former of IIoT agent module or device is SCADA of which the main purpose is to control and monitoring. All the features in SCADA such as real-time control, data logging, data exchange, data analyzing, alarm handler and visualization, in SCADA must be retained in IIoT agent module or device. First, real-time system control must guarantee response within specified time constraints. So, there must be a timer module to guarantee this specified time. Timer module will send a signal message to core module for every 1 second. When core module receives this signal, it will go through all the tasks such as data refreshing, scripts implementation, alarm handling and data logging.

Web-based HMI would be the choice for visualization module of IIoT agent module or device. That is Internet technology that use web browsers as visual screen for supervisory control and monitoring. The newest web-based technology is HTMLS, and Websockets that can enrich dynamic features in web browsers. Clients' devices need not any software installation or addons in web browsers. This implies that any change in IIoT agent module or device doesn't require re-installing software in client side. That's why web-based HMI is picked as visualization module design direction. In addition to system independent, one can control, manage and monitor one's system by PC, android devices or apple devices in everywhere.

To conclude, core module is the one who manage all internal and external registers, event and alarm list, creation of various IPC, and scripts implementation. All other modules surrounding to core module provide various addon features or specific communication abilities and keep data exchange through various IPC such as message queue and share memory. The external registers of core module would be kept in sync with external device registers. Internal registers will be assigned with the data generated from processing engine or script calculation. Even more, users can create more module to suit their purpose. As a result, all surrounding modules will create a data circulation flow with core module and thus data can be switched to various devices or IIoT cloud platform.

IIoT Agent Module or Device Internet Protocol

A several communication channels have been setup for above functions.:

Common registration channel/topic

Telemetry channel/topic

Heartbeat channel/topic

Service request channel/topic

Service response channel/topic

Registration

Every IIoT agent module or device must present its identity to the IoT platform to gain access right. In doing so, IIoT agent module or device must go through a registration process. At first start, IIoT agent module or device would automatically generate the UUID which is a unique ID for to distinguish between those agents who already connected to the same IIoT cloud platform. With this UUID at hand, IIoT agent module or device would subscribe the service request channel and place the registration request message to common registration channel.

Users must generate a serial number from the IIoT cloud platform and copy this serial number to IIoT agent module or device connection profile. This serial number is used for IIoT cloud platform to differentiate between IIoT agent module or devices. After restarting the IIoT agent module or device, it sends out this number together with registration information such as the hostname of device, model no., software version no., protocol version no., to IIoT cloud platform. IIoT cloud platform will check out this serial number whether connection is accepted. Then, check out UUID number whether exist or not, check out the software version or protocol version whether IIoT cloud platform support or not. Lastly, IIoT cloud give back the IIoT agent module or device whether registration request is acceptable.

Heartbeat

According to the present disclosure, at a specific time interval, such as every 5 seconds, IIoT agent module or device would send out a heartbeat message through the heartbeat channel to the IoT cloud platform to tell existence of itself. If IIoT cloud platform can't receive this heartbeat in certain time (e.g. 10 seconds), this IIoT agent module or device can be treated as dead. Moreover, Heartbeat message contains some useful information such as alarm status, mode status, communication status and data usage status for IIoT platform to understand the status of IIoT agent module or device.

Telemetry

IIoT agent module or device would send out a data stream called telemetry through the telemetry channel to IIoT cloud platform continuously. Telemetry structure will depend on how object and data points are designed by users and thus is dynamic and vary from projects. Timestamp may be also provided in this telemetry structure basic on the settings of configuration. Each object group would have a unique key which is Prefix+Object Name+Suffix as describe in follow section.

Service

IIoT agent module or device would provide a various kind of services for IIoT cloud platform to control its behavior such as restarting, activating, deactivating, and configuring. As describe above, IIoT agent module or device would subscribe the service request channel to listen messages coming from the IIoT platform. When a message comes, IIoT agent module or device will analyze what kind of service is asked for and perform the according service if all condition check is satisfied. Not only controlling the IIoT agent module or device, IIoT cloud can also control the machine directly by placing a request message on this service channel.

According to the present disclosure, generally speaking, there are 3 kinds of running phases for IIoT agent module or device to get connect to IIoT cloud platform. These are registration phase, configuration phase and running phase. To get itself running, one must complete the first 2 phases activities phase by phase. When one start running a fresh copy of IIoT agent module or device instance. It will try to registry itself to the IIoT cloud platform. If pass, it enters the second phase configuration. In this phase, users must construct an IIoT agent module or device configuration profile such as data points, objects, drivers in IIoT cloud platform which then send this configuration to IIoT agent module or device when users press “publish” to IIoT agent module or device which is in inactive mode, namely to an idling IIoT agent module or device, waiting for configuration to get itself running. After passing the configuration setup, IIoT agent module or device will enter to running phase.

In running phase, there will be 2 running modes available for gateway. These are active mode and standby mode. In active mode, IIoT agent module or device is fully operated with telemetry and data polling. Standby mode has no telemetry transfer and no data polling, and so is in silent state.

Object-Oriented Modeling and Address Matching

Object-oriented modeling is the construction of objects by using a collection of objects that contain stored values of the instance variables found within an object. It allows for object identification and communication while supporting data abstraction, inheritance and encapsulation. This will be the best technique for users to create their data structure in IIoT cloud and use this same data structure all over the IIoT cloud and IIoT agent module or device.

When developing a project on the top of the IIoT system, all user has to do is identifying all objects that will be used in automated systems in various plants and then state these objects with its matching data points details clearly in configuration.

On the top of objects' variables, one can identify some of them that need to be controlled and write some algorithm statements in the script's engine to implement the supervisory control. One need not to know too much underlying programming details about communication protocols, PLC addressing, alarm handling, data acquisition and real-time issues. All these difficulties would be taken care by IIoT agent module or device.

Object is the real-world entity that has some certain characteristics that are identified as attributes values for the object. Each attribute is just a data point of IIoT agent module or device. Object is an entity encapsulating all data points as attributes. Therefore, when creating a project in IIoT cloud, users have to organize those data points in an Object-Attribute structure.

IIoT system usually uses key value stores as NoSQL database because of its simplicity, and its better persistence and indexing. In addition, key-value stores can also handle unstructured data in a fantastic manner. Therefore, Key value pair data transmit must be required in IIoT agent module or device. There must be a translation method to make data points of Object-Attribute structure into Key value pair data structure. Here is an example.

A device ST1021 can detect both humidity and temperature of a room. Data points description would be like this:

Object (OBJECT)-ST1021

| ATTRIBUTES | VALUE |
|---|---|
| TEMPERATURE | 23.4 |
| Humidity (HUMIDITY) | 76.8 |

Among them, ST1201 is a relevant object which is just a device detecting the temperature and humidity. The simple way to make it to KVP is to add the object name before the attributes.

| KEY/DATA POINTS | VALUE |
|---|---|
| ST1021-TEMPERATURE | 23.4 |
| ST1021-HUMIDITY | 76.8 |

Now the situation is more complicated. Suppose one might have 2 rooms and each room have 2 such devices. So, how can one represent in the data point? The answer is to add prefix and suffix descriptions to the object. After adding the prefix and suffix, the example would be like this:

| KEY/DATA POINT | VALUE |
|---|---|
| R1_ST1021_1-TEMPERATURE | 28.2 |
| R1_ST1021_1-HUMIDITY | 81.8 |
| R1_ST1021_2-TEMPERATURE | 23.4 |
| R1_ST1021_2-HUMIDITY | 76.8 |
| R2_ST1021_1-TEMPERATURE | 16.4 |
| R2_ST1021_1-HUMIDITY | 46.8 |
| R2_ST1021_2-TEMPERATURE | 17.9 |
| R2_ST1021_2-HUMIDITY | 39.1 |

In this case, the prefix R1 and R2 means room 1 and room 2. The suffix 1 and 2 represent the first and second device in the room. Totally one could get 8 data points at the same time. By adding prefix and suffix to the objects who have same attributes, one can differentiate the individual object from the class.

So, each KEY represents a data point in register list for IIoT agent module or device. In a certain period, Data in these registers, no matter internal or external, would be encapsulated as key value pair in object package to be transferred to IIoT cloud. On the other hand, each data point also links to one or a contiguous field device address. Users usually call this field device address as tag address. The representation of these tag addresses is varying from device to device. This is because various device markers have their own standards of address format. For some examples,

Siemens—BD1DW100

Mitsubishi—D1000

Omron—D1000

Modbus address—2!W1000

Each device contains a list of data points with attached addresses which have some properties such as data type, register area, register address and operation size. These properties must be abstracted to general processing details for manipulation.

Lastly, done does not simply use this Device-Tag data structure to encapsulate data points instead one might use Object-Attribute data structure. Object-Attribute structure are very similar to Device-Tag structure, but they have difference meaning in general. An Object one can encapsulate any register across different devices. These objects with their own attributes are understandable for human. A Device is just a hardware that a list of registers resides in, these registers could be read through a physical wire without any logical relationship or order. Device-Tag structure may not be difficult to human understanding.

Let's see an example, suppose one might has 3 water tanks which need temperature control in a specific level with minimum power consumption. Two kinds of data are needed. First, one might need temperature of each tank. Second is the energy reading of tank heater.

As shown in FIG. 5, temperature controller can read 3 tanks' temperature at the same time. Through a proper hardware communication protocol, temperature controller will give out 3 temperature readings together to IIoT agent module or device. On the other hand, 3 energy meters will transmit the energy data to IIoT agent module or device individually. This Device-Tag structure will be re-organized into Object-Attribute structure. Water tank would be treated as Object. Temperature and energy usage are the attributes of this object. Users would have clearer concept about what is water tank for.

Referring to FIG. 5, as described above, one might have two levels of view for data structure presentation. First is Device-Tag structure and second is Object-Attribute structure. In low level view, all data are retrieved from various devices at different locations. The data organization method depends on physical wiring. These data structure must be re-organized into human understandable concept during configuration. That means users have to define the matching between two levels in configuration details for IIoT agent module or device.

So, the matching details for each object will be like

| Device address | key-value pair |
|---|---|
| DB1DW1000 | R1_ST1021_1-TEMPERATURE |
| DB1DW1002 | R1_ST1021_1-HUMIDITY |
| DB1DW1004 | R1_ST1021_2-TEMPERATURE |
| DB1DW1006 | R1_ST1021_2-HUMIDITY |

In summary, according to the present disclosure, it generally provides an Industrial Internet of Things (IIoT) agent module or device, preferably used as or in place of a Supervisory Control and Data Acquisition (SCADA) data node system and/or a conventional SCADA system, which is operatively coupled and in communication with an IIoT cloud platform, so as to perform a supervisory control and data acquisition operation and exchange data and command automatically or in response to an input from the IIoT cloud platform; wherein all production details/settings/parameters, including process logic, control methodology, product recipe, and data point setup, can be dynamically changed based on a decision/input/command of the IIoT cloud platform, such that the IIoT cloud platform might completely “re-configure/re-program” a software portion of the IIoT agent module or device governing its working behavior or characteristics by sending a reconfiguration/reprogramming information or message; the “reconfiguration/reprogramming” information is equivalent to the configuration of the IIoT agent module or device.

In some embodiments, wherein the IIoT agent module or device is configured to be disabled/idle or inactivated during initial startup or operation, until the IIoT cloud platform performs initial configuration or reconfiguration/reprogramming for it; and the IIoT agent module or device is configured to control and monitor production after being configured or reconfigured/reprogrammed by the IIoT cloud platform, and then transfer corresponding preset or agreed data to the IIoT cloud platform; and the IIoT cloud platform might implement a machine learning algorithm based on the data, and might send a reconfiguration/reprogramming instruction to the IIoT agent module or device at any time to realize a complete control loop of IIoT system.

In other embodiments, wherein the IIoT agent module or device is configured to operate in a “micro” environment of manufacturing for collecting and visualizing a day-to-day operation data of a factory or a process; and the IIoT cloud platform is configured to concentrate on a “macro” environment of manufacturing for solving pertinent questions hanker in quest for optimal productivity.

In some embodiments, wherein the IIoT agent module or device is configured to provide security assurance to the IIoT cloud platform; wherein the IIoT agent module or device is preferably configured to have direct connection between field devices and/or programmable logic controllers (PLCs) for conducting supervisory control and data acquisition operations, and transmit an accurate data and result to the IIoT cloud platform, so as to ensure accuracy of signal communication of control system and system security of IIoT.

In other embodiments, wherein all data points setup could be taken place in the IIoT cloud platform, such that kind and number of data points being transferred could be designed based on configuration details/detailed data in IIoT cloud platform; and/or the configuration details/detailed data in the IIoT cloud platform can be changed in anytime, from any place to demand more different types of data point transfer to facilitate interoperability of system.

In further embodiments, wherein adding a new device or changing connection infrastructure might be taken place in configuration process of IIoT cloud platform to facilitate scalability of system, and a new configuration will then be delivered to a corresponding IIoT agent module or device, so as to monitor and control the new device accordingly; preferably, any amendment of current configuration in IIoT agent module or device might be completely done at one time in a IIoT cloud platform at remote side, so that there is no need to repeatedly perform configuration updates on both the IIoT agent module or device and the IIoT cloud platform through manual operations; and wherein configuration consistence could be assured between IIoT agent module or device and the IIoT cloud platform, as if, by mistake, the configuration between them are somehow different, data points transfer will be mismatched, such that a system behavior may not be as same as an expectation of the IIoT cloud platform.

In yet still other embodiments, wherein the IIoT agent module or device is configured to actually works on behalf of the IIoT cloud platform to perform supervisory control and data acquisition duty, so as to facilitate centralized control of system; and wherein actual behavior and outcome of production must obey to willingness of the IIoT cloud platform, and any misbehavior of IIoT agent module or device might be regulated via a remote configuration update, such that the IIoT cloud platform could take full control of whole manufacturing process.

In some embodiments, wherein a new IIoT agent module or device can be integrated onto the IIoT cloud platform to perform manufacturing simulation according to a reconfiguration/reprogramming information or instruction, such that issues related to safety and/or production efficiency of IIoT system employing a newly configured IIoT agent module or device could be solved or reduced by predicting potential risks of the new configuration before using the newly configured IIoT agent module or device.

In further embodiments, wherein the IIoT cloud platform is configured to comprise a real-time data storage area for storing/collecting a real-time data of production and preferably a real-time data generated/collected during factory production, and a simulation data storage area for storing/collecting a data during manufacturing simulation, and a configuration profile data storage area for storing/collecting a configuration setup data of all IIoT agent modules or devices, and such storage areas are arranged for simulation processing; wherein a production result and/or efficiency depends on the configuration setup data, and the configuration setup data is preferably determined by at least one manufacturing simulation/testing, and when a new configuration setup data is determined/configured, a manufacturing simulation is conducted to output a simulation data with the new configuration setup data, and the simulation data is compared with a real-time data inputted/collected in advance to determine whether the new configuration setup data realizes an expected production result and/or a target value of efficiency; and/or
the IIoT cloud platform is configured to further comprise:
an AI processing module to facilitate the comparison between the simulation data generated with the new configuration setup data and the real-time data inputted/collected in advance to determine whether the new configuration setup data realizes an expected production result and/or a target value of efficiency, and a new configuration setup data is generated when the expected production result and/or target value of efficiency had not been realized, and then a manufacturing simulation is conducted repeatedly to output a new simulation data for comparison with the real-time data inputted/collected in advance, until the expected production result and/or the target value of efficiency had been realized; and/or
a communication/information transfer processing module to facilitate transmission of data, information, and/or control commands between the IIoT agent module or device and the IIoT cloud platform; and/or
a corresponding number of IIoT agent module or device required by or configured for manufacturing simulation, for example the number might be corresponding or equivalent to the number of IIoT agent module or device at remote side, wherein IIoT agent module or device at remote side comprises a device driver program or a device driver for external communication with an external device, and the IIoT agent module or device of the IIoT cloud platform comprises a simulation driver program or a simulation driver dedicated for internal communication of the IIoT cloud platform.

In yet still other embodiments, wherein two or more IIoT agent modules or devices can form a group to provide a clustering of IIoT agent modules or devices, whereby enabling a switching over from a problematic IIoT agent module or device to a standby IIoT agent module or device for reducing downtime or idle hour via a remote configuration mechanism when a hardware failure occurs; and preferably, a clustering model of IIoT agent modules or devices comprises a duplicated clustering model employing a double amount of IIoT agent modules or devices adapted for working in pair, wherein one of each pair of the IIoT agent modules or devices is an active IIoT agent module or device, and the other is a standby IIoT agent module or device, and a switch over might happen between each pair of IIoT agent modules or devices; and a N+1 clustering model employing N active IIoT agent modules or devices and a singular standby IIoT agent module or device for enabling a switch over between them.

According to the present disclosure, the IIoT agent module or device is configured to simulate or function as a neuron to form or implement a reflex action in response to manufacturing tasks or operating states or events of the system, thereby automatically making or conducting required responses or processing. Just as in the Knee Jerk Reflex experiment, the lower leg of the experimenter kicks unintentionally in response to a sharp tap below the kneecap or on the patellar tendon thereof.

Reflexes require no thought. They are automatic, fast, and of huge importance to a human's ability to successfully respond to their environment. Despite the magnificent information-processing power of the billions of neurons in one's brain, one might need a lot of stuff to be done automatically. Without reflexes, one's brain would be overloaded with worrying about constantly updating the position of one's unstable body to keep it upright, for example. Second, one's ability to engage in complex thought such as study, organize work and remember things would be limited. Lastly, one's reactions to painful stimuli would require thought and thus the response will be much slower.

As a result, in the nervous system, the reflexes mechanism is super useful for correcting one's muscle action in response to rapid danger situation such as a slip or trip, wherein the reflexes mechanism enables and provides very fast corrections to prevent falling and injury.

According to the present disclosure, the IIoT cloud platform might be configured to simulate or play the role of the brain, and the IIoT agent module or device could be configured to simulate or play the role of spinal cord neurons. When the sensor sends signals to the IIoT agent module or device, which can immediately respond to these signals to perform corresponding appropriate operations, thereby simulating the reflexes mechanism of the human body. According to the embodiments of the present disclosure, wherein the motion control and monitoring duties are assigned to remote IIoT agent modules or devices (spinal neurons), in order to respond as soon as possible to the rapidly changing manufacturing and production environment and present the IIoT cloud platform (brain) or the entire system from being overloaded.

It is obvious that the features and attributes of the specific embodiments disclosed above can be combined in different ways to form additional embodiments, and all these embodiments shall fall within the scope of the present disclosure.

The conditional language used herein, such as “can”, “could”, “might”, “may”, “for example”, etc., unless otherwise expressly stated, or can be understood in other ways in the context thereof, It is generally meant to convey that certain embodiments include, while other embodiments do not include certain features, components, elements, steps, and/or states. Therefore, such conditional language is generally not intended to imply that one or more embodiments require the described features, components, elements, steps, and/or states in any case.

The present disclosure has been described above with reference to specific embodiments. However, other embodiments than the above are equally possible within the scope of the present disclosure. Method steps different from those described above can be provided within the scope of the present disclosure. The different features and steps of the present disclosure can be combined into other combinations than those described. The scope of the present disclosure might only be limited by the appended claims.

What is claimed is:

1. An Industrial Internet of Things (IIoT) agent module or device, preferably configured to take part in an automated IIoT system and used as or in place of a Supervisory Control and Data Acquisition (SCADA) data node system and/or a conventional SCADA system, which is operatively coupled and in communication with an IIoT cloud platform, so as to perform a supervisory control and data acquisition operation and exchange data and command automatically or in response to an input from the IIoT cloud platform; wherein all production details, settings, or parameters, including process logic, control methodology, product recipe, and data point setup, can be dynamically changed based on a decision, input, or command of the IIoT cloud platform, such that the IIoT cloud platform might completely “re-configure or re-program” a software portion of the IIoT agent module or device governing its working behavior or characteristics by sending a reconfiguration/reprogramming information or message; wherein the “reconfiguration/reprogramming” information is equivalent to the configuration of the IIoT agent module or device.

2. The module or device of claim 1, wherein the IIoT agent module or device is configured to be disabled, idle or inactivated during initial startup or operation, until the IIoT cloud platform performs initial configuration or reconfiguration/reprogramming for it; and the IIoT agent module or device is configured to control and monitor production after being configured or reconfigured/reprogrammed by the IIoT cloud platform, and then transfer corresponding preset or agreed data to the IIoT cloud platform; and the IIoT cloud platform might implement a machine learning algorithm based on the data, and might send a reconfiguration/reprogramming instruction to the IIoT agent module or device at any time to realize a complete control loop of IIoT system.

3. The module or device of claim 1, wherein the IIoT agent module or device is configured to operate in a “micro” environment of manufacturing for collecting and visualizing a day-to-day operation data of a factory or a process; and the IIoT cloud platform is configured to concentrate on a “macro” environment of manufacturing for solving pertinent questions hanker in quest for optimal productivity.

4. The module or device of claim 1, wherein the IIoT agent module or device is configured to provide security assurance to the IIoT cloud platform; wherein the IIoT agent module or device is preferably configured to have direct connection between field devices and/or programmable logic controllers (PLCs) for conducting supervisory control and data acquisition operations, and transmit an accurate data and result to the IIoT cloud platform, so as to ensure accuracy of signal communication of control system and system security of IIoT.

5. The module or device of claim 1, wherein all data points setup could be taken place in the IIoT cloud platform, such that kind and number of data points being transferred could be designed based on configuration details/detailed data in IIoT cloud platform; and/or the configuration details/detailed data in the IIoT cloud platform can be changed in anytime, from any place to demand more different types of data point transfer to facilitate interoperability of system.

6. The module or device of claim 1, wherein adding a new device or changing connection infrastructure might be taken place in configuration process of IIoT cloud platform to facilitate scalability of system, and a new configuration will then be delivered to a corresponding IIoT agent module or device, so as to monitor and control the new device accordingly; preferably, any amendment of current configuration in IIoT agent module or device might be completely done at one time in the IIoT cloud platform at remote side, so that there is no need to repeatedly perform configuration updates on both the IIoT agent module or device and the IIoT cloud platform through manual operations; and wherein configuration consistence could be assured between IIoT agent module or device and the IIoT cloud platform, as if, by mistake, the configuration between them are somehow different, data points transfer will be mismatched, such that a system behavior may not be as same as an expectation of the IIoT cloud platform.

7. The module or device of claim 1, wherein the IIoT agent module or device is configured to actually works on behalf of the IIoT cloud platform to perform supervisory control and data acquisition duty, so as to facilitate centralized control of system; and wherein actual behavior and outcome of production must obey to willingness of the IIoT cloud platform, and any misbehavior of IIoT agent module or device might be regulated via a remote configuration update, such that the IIoT cloud platform could take full control of whole manufacturing process.

8. The module or device of claim 1, wherein a new IIoT agent module or device can be integrated onto the IIoT cloud platform to perform manufacturing simulation according to a reconfiguration/reprogramming information or instruction, such that issues related to safety and/or production efficiency of IIoT system employing a newly configured IIoT agent module or device could be solved or reduced by predicting potential risks of the new configuration before using the newly configured IIoT agent module or device.

9. The module or device of claim 1, wherein the IIoT cloud platform is configured to comprise a real-time data storage area for storing/collecting a real-time data of production and preferably a real-time data generated/collected during factory production, and a simulation data storage area for storing/collecting a data during manufacturing simulation, and a configuration profile data storage area for storing/collecting a configuration setup data of all IIoT agent modules or devices, and such storage areas are arranged for simulation processing; wherein a production result and/or efficiency depends on the configuration setup data, and the configuration setup data is preferably determined by at least one manufacturing simulation/testing, and when a new configuration setup data is determined/configured, a manufacturing simulation is conducted to output a simulation data with the new configuration setup data, and the simulation data is compared with a real-time data inputted/collected in advance to determine whether the new configuration setup data realizes an expected production result and/or a target value of efficiency; and/or the IIoT cloud platform is configured to further comprise: an AI processing module to facilitate the comparison between the simulation data generated with the new configuration setup data and the real-time data inputted/collected in advance to determine whether the new configuration setup data realizes an expected production result and/or a target value of efficiency, and a new configuration setup data is generated when the expected production result and/or target value of efficiency had not been realized, and then a manufacturing simulation is conducted repeatedly to output a new simulation data for comparison with the real-time data inputted/collected in advance, until the expected production result and/or the target value of efficiency had been realized; and/or a communication/information transfer processing module to facilitate transmission of data, information, and/or control commands between the IIoT agent module or device and the IIoT cloud platform; and/or a corresponding number of IIoT agent module or device required by or configured for manufacturing simulation, wherein IIoT agent module or device at remote side comprises a device driver program or a device driver for external communication with an external device, while the IIoT agent module or device of the IIoT cloud platform comprises a simulation driver program or a simulation driver dedicated for internal communication of the IIoT cloud platform.

10. The module or device of claim 1, wherein two or more IIoT agent modules or devices can form a group to provide a clustering of IIoT agent modules or devices, whereby enabling a switching over from a problematic IIoT agent module or device to a standby IIoT agent module or device for reducing downtime or idle hour via a remote configuration mechanism when a hardware failure occurs; and preferably, a clustering model of IIoT agent modules or devices comprises a duplicated clustering model employing a double amount of IIoT agent modules or devices adapted for working in pair, wherein one of each pair of the IIoT agent modules or devices is an active IIoT agent module or device, and the other is a standby IIoT agent module or device, and a switch over might happen between each pair of IIoT agent modules or devices; and a N+1 clustering model employing N active IIoT agent modules or devices and a singular standby IIoT agent module or device for enabling a switch over therebetween.
